(19) United States
(12) Patent Application Publication
(10) Pub. No.: US 2009/0213008 A1
(43) Pub. Date: Aug. 27, 2009

(54) Multiple RF receiver and locating method using the same

(75) Inventors: Yun-Ju Paek, Busan (KR); Hyun-Tae Cho, Busan (KR); Hyun-Sung Jang, Busan (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: Pusan National University Industry-University Cooperation Foundation

(21) Appl. No.: 12/320,451

(22) Filed: Jan. 27, 2009

(30) Foreign Application Priority Data
Feb. 27, 2008 (KR) 10-2008-0017912

(51) Int. Cl. G01S 1/24

(52) U.S. Cl. 342/387

(57) ABSTRACT

A multiple RF receiver and locating method using the same have developed. The multiple RF receiver includes: a clock generator for generating a clock according to multiple RF receiving modules included in a multiple RF receiving unit; a phase distributor for dividing the clock into clocks having different phases, and providing the clocks to the multiple RF receiving unit as clock sources; the multiple RF receiving unit for generating SFD (Start of Frame Delimiter) signals by using the phases of the clocks provided as the clock sources; and a time measuring unit for measuring the SFD signals for use as data for location measurement.

### BACKGROUND OF THE INVENTION

1. Field of the invention

The present invention relates to a multiple RF receiver and a locating method using the same, and more particularly to a multiple RF receiver which makes it possible to precisely measure a signal by minimizing a jitter occurring in a receiver, and a locating method using the same, the jitter having the strongest effect on location measurement.

2. Description of the Prior Art

In location estimation by using a time difference of arrival of radio frequencies, reception times of transmitter (tag) signals are measured by two or more receivers, and the difference between the times is used.

Since a radio signal has a constant speed, it is possible to calculate the difference between reception times with the proviso that two receivers are time-synchronized. Accordingly, a transmitter location exists on a hyperbola.

The difference may be converted into a distance difference between two vertexes on the hyperbola, and may be used to obtain curves of different receiver couples. In location estimation by using a time difference of arrival of radio frequencies, two or more such curves are obtained, and the intersection point is estimated as the location of a transmitter. When a transfer time of a radio signal is exactly known, it is possible to determine an exact location of an RTLS (Real Time Locating System) transmitter.

However, measurement on the transfer time of the radio signal may have a non-deterministic error. The non-deterministic error includes a transmission delay, an access delay, a reception delay and a transfer delay. It is possible to remove the transmission delay, the access delay, and the reception delay through a time stamp by the hardware. The transfer delay is divided into: a delay in radio signal transfer from an RTLS transmitter antenna to an RTLS receiver antenna; and a delay in an encoding time of a digital signal into an analogue signal in a physical layer, and a delay in a decoding time of a sampled analogue signal into a digital signal in a receiving side physical layer. The delay from the RTLS transmitter antenna to the RTLS receiver may be removed by using the transmission speed of the radio signal.

However, it is impossible to remove the delay in the encoding time and the decoding time occurring in an RF transceiver of the RTLS transmitter/receiver. Thus, such an error has existed in time synchronization using a wireless network between receivers, and in location measurement in a real time locating system.

Also, in the case of a locating system using a time difference of arrival of radio frequencies, since the location of an RTLS transmitter is measured based on a relative signal arrival time between RTLS receivers, a decoding time of an RTLS receiver plays an important role in exactly determining a message reception time. Meanwhile, a message encoding time and a transfer delay in the RTLS transmitter are not included.

The reception time in the RTLS receiver is determined by a processor timer, and a time stamp is provided by the RF transceiver. In the process of converting a radio frequency into a digital value, a non-deterministic error, that is, a jitter, occurs, which is a location measurement error having existed in a real time locating system.

Therefore, in order to solve the above mentioned problem, a requirement for minimizing a decoding jitter occurring in the RTLS receiver has been made.

### SUMMARY OF THE INVENTION

An object of the present invention is to provide a multiple RF receiver and a locating method using the same in order to minimize a decoding jitter occurring in a conventional RTLS receiver.

Also, another object of the present invention is to minimize a decoding jitter by using a precise digital clock, instead of an analogue clock, as a clock source. Also, a further object of the present invention is to exactly shift phases of input clock sources so that the clock sources can be used in respective receivers. Also, a still further object of the present invention is to change a digital clock phase of each clock source by using a flip-flop.

Also, yet another object of the present invention is to use a wireless network in synchronization, the network requiring no infrastructure (such as internet), and to allow receivers to locally time-synchronize with each other with no external time server.

Also, still yet another object of the present invention is to provide time-synchronization down to a nano second via a wireless network by removing uncertainty that may occur during time-synchronization.

A multiple RF receiver according to an embodiment of the present invention includes: a clock generator for generating a clock; a phase distributor for dividing the generated clock into clocks having different phases according to multiple RF receiving modules included in a multiple RF receiving unit, and providing the divided clocks to the multiple RF receiving unit as clock sources; the multiple RF receiving unit including the multiple RF receiving modules which generate SFD(Start of Frame Delimiter) signals, respectively, by using the phases of the clocks provided as the clock sources; and a time measuring unit for measuring the SFD signals for use as data for location measurement.

A multiple RF receiver according to another embodiment of the present invention includes: a multiple RF receiving unit including multiple RF receiving modules which generate SFD signals, respectively, by using clocks provided as clock sources; a phase distributor for dividing a clock input from a clock generator into the clocks having different phases according to the multiple RF receiving modules, and providing the divided clocks to the multiple RF receiving unit as the clock sources; and a time measuring unit for measuring the SFD signals for use as data for location measurement.

Preferably, the multiple RF receiving unit uses one common antenna to receive radio frequencies. Preferably, the phase distributor changes a phase of the clock by using a flip-flop. Preferably, the multiple RF receiver includes one master receiver for periodically transmitting a time synchronization message including time information, and a slave receiver for synchronizing its time by receiving a reference time from the master receiver based on the SFD signals generated by the multiple RF receiving unit.

According to an embodiment of the present invention, a method of measuring a location of a transmitter by using a time difference of arrival (TDOA) of radio frequencies in a locating system including multiple receivers, one transmitter, and an RTLS engine, the method including the steps of: (a) generating a clock by a clock generator; (b) dividing, by a phase distributor, the generated clock into clocks having different phases according to multiple RF receiving modules included in a multiple RF receiving unit, and providing the divided clocks to the multiple RF receiving unit as clock sources; (c) generating, by the multiple RF receiving unit, SFD signals through the RF receiving modules by using the phases of the clocks provided as the clock sources; and (d) measuring, by a time measuring unit, the SFD signals to be provided to the RTLS engine, thereby allowing the RTLS engine to measure the location of the transmitter by using the SFD signals.

According to another embodiment of the present invention, a method of measuring a location of a transmitter by using a time difference of arrival (TDOA) of radio frequencies in a locating system including multiple receivers, one transmitter, and an RTLS engine, the method including the steps of: (A) dividing, by a phase distributor, a clock generated by a clock generator into clocks having different phases according to multiple RF receiving modules included in a multiple RF receiving unit, and providing the divided clocks to the multiple RF receiving unit as clock sources; (B) generating, by the multiple RF receiving unit, SFD signals through the RF receiving modules by using the phases of the clocks provided as the clock sources; and (C) measuring, by a time measuring unit, the SFD signals to be provided to the RTLS engine, thereby allowing the RTLS engine to measure the location of the transmitter by using the SFD signals.

Preferably, a flip-flop is used to change a phase of the clock. Preferably, the method further includes the steps of: transmitting periodically, by one master receiver of the multiple receivers, a time synchronization message including time information to other receivers; and receiving, by the other receivers of the multiple receivers, except the master receiver, the time synchronization message transmitted from the master receiver, and time-synchronizing their times based on the SFD signals generated by the multiple RF receiving unit. Preferably, one common antenna is used for receiving a time stamp message of the master reader.

### BRIEF DESCRIPTION OF THE DRAWINGS

FIG. 1 is a conceptual view showing a locating system.

FIG. 2 illustrates a method of measuring a location of a transmitter by using a hyperbola.

FIG. 3 illustrates a message of a transmitter.

FIG. 4 illustrates a block diagram of a general RTLS receiver.

FIG. 5 illustrates an example of a jitter that may occur in an RF transceiver of FIG. 4.

FIG. 6 illustrates a block diagram of a multiple RF receiver according to an embodiment of the present invention.

FIG. 7 illustrates a clock generating process by a clock generator shown in FIG. 6.

FIG. 8 illustrates a structure of a phase distributor (shown in FIG. 6) for frequency division.

FIG. 9 illustrates a process of generating a clock.

FIG. 10 illustrates, in order, phase shifts resulting from the process of FIG. 9.

FIG. 11 is a flow chart showing a locating method using the multiple RF receiver according to an embodiment of the present invention.

### DETAILED DESCRIPTION OF THE EXEMPLARY EMBODIMENTS

Hereinafter, advantages and characteristics of the present invention, and a method thereof will be clear with reference to the accompanying drawings and the following detailed exemplary embodiments. However, the scope of the invention is not to be limited by the embodiments, but may be variously embodied. The present embodiments are provided for complete disclosure of the present invention, and to fully inform the scope of the present invention to those ordinarily skilled in the art. The present invention is defined only by the appended claims. The same reference numerals are used to designate the same or similar components.

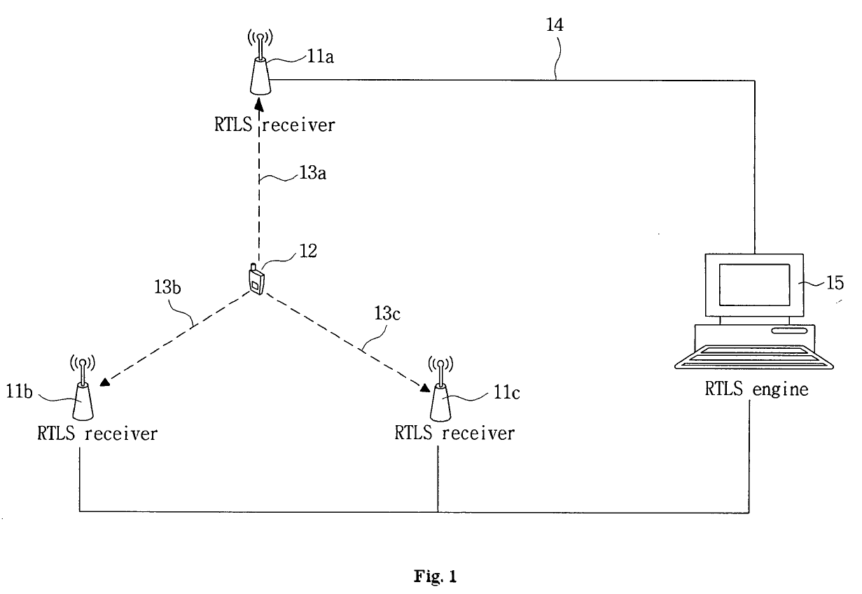

FIG. 1 is a conceptual view showing a locating system. A (real time) locating system includes a (RTLS) transmitter 12, (RTLS) receivers 11a, 11b, and 11c, and an RTLS engine 15. The RTLS transmitter 12 (tag) using a time difference of arrival (TDOA) of radio frequencies transfers its own information to the receivers 11a, 11b, and 11c (reader) through radio frequencies 13a, 13b and 13c, and each of the RTLS receivers 11a, 11b, and 11c receives a message of the transmitter 12, records a reception time of the message (a radio frequency), and transfers (14) the record to the RTLS engine 15. The RTLS engine 15 receives the reception time of the message from each of the receivers 11a, 11b, and 11c, and determines the location of the transmitter 12 by using the same.

In a locating method using a TDOA of radio frequencies, two or more receivers measure reception times of signals from a transmitter, and an RTLS engine measures the location of the transmitter by using the difference between the times. Since a radio signal has a constant speed, it is possible to calculate the difference between reception times with the proviso that two receivers are time-synchronized. Thus, a transmitter location exists on a hyperbola.

For example, when messages of signals transmitted from the transmitter 12 are received by the receivers 11a, 11b, and 11c at the same time, the transmitter 12 is located at the same distance from the three receivers 11a, 11b and 11c. Hereinafter, the system will be described in detail with reference to an embodiment.

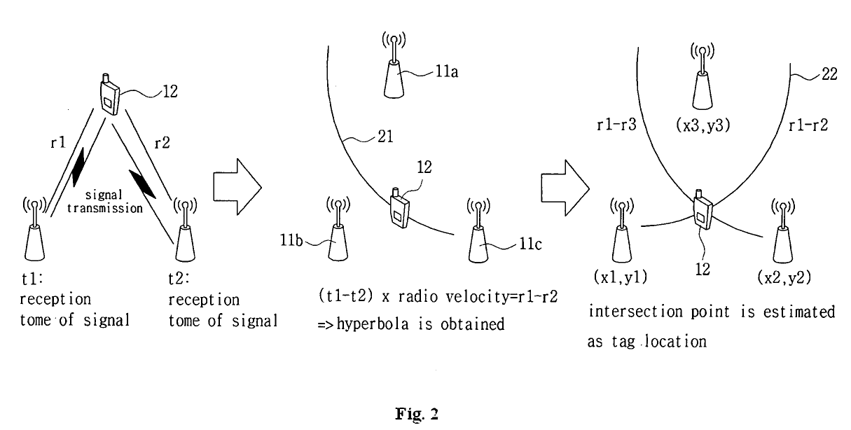

FIG. 2 illustrates a method of measuring a location of a transmitter by using a hyperbola. Referring to FIG. 2, in a locating method using a TDOA of radio frequencies, times t1 and t2 when one receiver 11b and another receiver 11c receive signals from the transmitter 12 are recorded, and a difference between the times t1 and t2 is used. Since a radio signal has a constant speed, it is possible to calculate the difference between reception times t1-t2, with the proviso that two receivers 11b and 11c are time-synchronized. Thus, the location of the transmitter 12 exists on a hyperbola 21. The difference may be converted into a distance difference between two vertexes on the hyperbola 21, and may be used to obtain curves of different receiver couples. In locating method using a TDOA of radio frequencies, two or more such curves 21 and 22 are obtained, and the intersection point is estimated as the location of the transmitter 12.

As described above, a method of measuring a location of a transmitter by using a TDOA of radio frequencies requires precise time measurement. For example, a time measurement error of 1 nanosecond causes a location error of 30 centimeters. Also, in order to exactly record reception times of messages from the transmitter, the receivers are required to set a common time as a time stamp point.

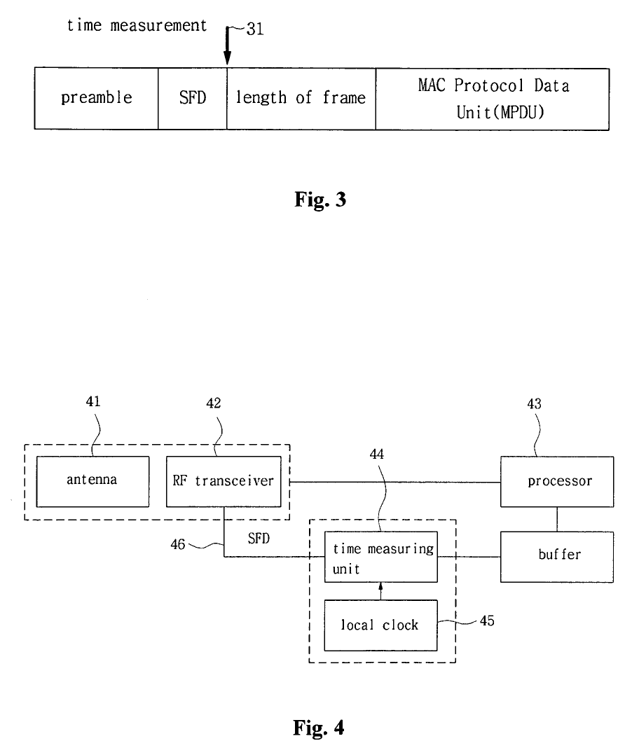

FIG. 3 illustrates a message of a transmitter. As shown in FIG. 3, a receiver sets, as a time stamp, the end of a SFD (Start of Frame Delimiter) signal 31 following a preamble.

Meanwhile, FIG. 4 illustrates a block diagram of a general RTLS receiver. As shown in FIG. 4, the RTLS receiver includes an antenna 41, an RF transceiver 42, a processor 43, a time measuring unit 44, and a local clock 45. Also, the RTLS receiver includes a buffer for buffering data.

A radio message of a transmitter is transferred to the RF transceiver 42 through the antenna 41 of the receiver, and the RF transceiver 42 modulates an analogue signal into a digital signal, generates an SFD signal 46, and transmits the modulated data to the processor 43 so that the data can be processed. Herein, the time measuring unit 44 determines the point where the SFD signal 46 is generated, as a reception point of the message of the transmitter, and performs time measurement through the local clock 45. Herein, the measured time information is transferred to the RTLS engine 15 via the processor 43 and is utilized for measuring the location of the transmitter.

In the RF transceiver 42, during a process of converting a radio frequency into digital data, a delay and a jitter occur. The delay occurring in the RF transceiver 42 can be removed because it has a constant value, while the jitter cannot be estimated because it has uncertainty.

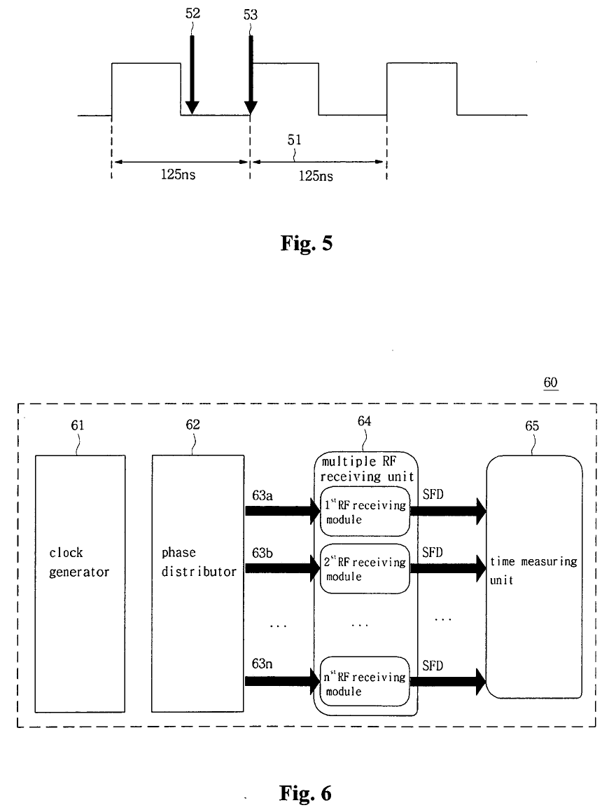

FIG. 5 illustrates an example of a jitter that may occur in the RF transceiver of FIG. 4. Referring to FIG. 5, when the chip rate of the RF transceiver 42 is assumed to be 8 MHz, a repetition cycle 51 of a clock is 125 nanoseconds. Herein, even though a radio frequency signal is received at a first time point 52, the RF transceiver 42 recognizes the reception at its clock cycle, a second time point 53 (that is, a rising edge). This is because the RF transceiver 42 uses a digital clock source. Herein, an error that may occur ranges from 125 nanoseconds to 0. Such an error is a jitter which may vary according to radio frequency signal measurement.

In order to minimize the error occurring in the RF transceiver 42, components of an RTLS receiver as shown in FIG. 6 may be used. FIG. 6 illustrates a block diagram of a multiple RF receiver according to an embodiment of the present invention.

As shown in FIG. 6, the multiple RF receiver 60 includes a clock generator 61, a phase distributor 62, a multiple RF receiving unit 64, and a time measuring unit 65. The multiple RF receiver 60 may be included in an RTLS receiver that receives a radio signal (frequency) from a transmitter.

The clock generator 61 generates a (digital) clock. In other words, the clock generator 61 generates the clock according to the number of multiple RF receiving modules included in the following multiple RF receiving unit 64.

The phase distributor 62 shifts a phase so that the provided clock can be used in the multiple RF receiving unit 64. In other words, the phase distributor 62 divides the clock into clocks having different phases so as to provide the clocks to the multiple RF receiving unit 64 as clock sources.

To the multiple RF receiving unit 64, the clock sources 63a to 63n which have different phases are provided. The multiple RF receiving unit 64 utilizes the clock sources to generate SFD (Start of Frame Delimiter) signals. The RF transceiver 42 in FIG. 4 may correspond to one of predetermined RF receiving modules included in the multiple RF receiving unit 64. In other words, n RF transceivers 42 as shown in FIG. 4 may exist in the multiple RF receiving unit 64.

Then, the time measuring unit 65 measures the SFD signals, and provides the result to an RTLS engine.

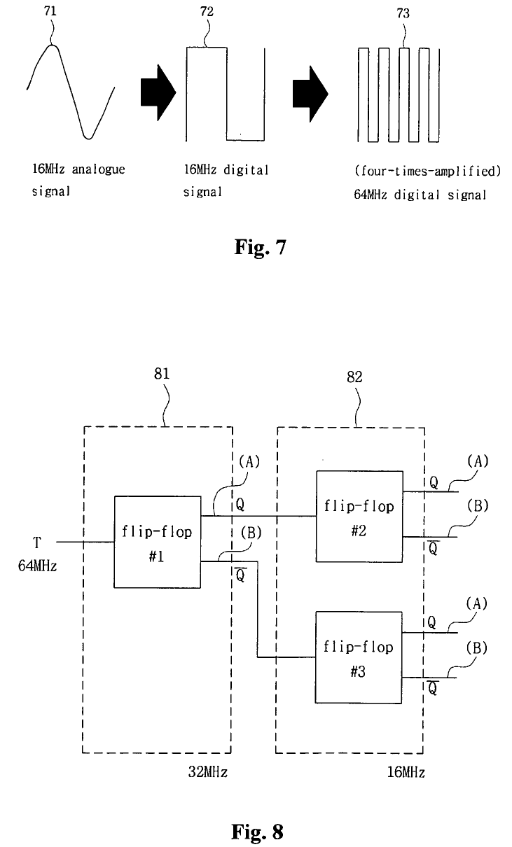

Hereinafter, the present invention will be described in greater detail with reference to FIG. 7. FIG. 7 illustrates a clock generating process by a clock generator shown in FIG. 6.

As shown in FIG. 7, first, an oscillator or a crystal in the clock generator provides a clock. If a certain module in the multiple RF receiving unit 64 operates at 16 MHz, the oscillator or the crystal provides a 16 MHz analogue clock 71. Then, the clock generator 61 receives the clock (that is, an analogue signal) and changes it into a digital clock 72 (that is, a digital signal) with the same frequency. Next, through a PLL (phase locked loop), the changed digital clock is multiplied by the required number of phases so as to generate a digital clock 73 having a high frequency.

Herein, a frequency (a digital signal) to be amplified varies according to the number of modules included in the multiple RF receiving unit 64. For example, in order to use four modules in the multiple RF receiving unit 64, a four-times-amplified frequency, 64 MHz, is generated.

The generated 64 MHz digital clock is input to the phase distributor 62, and the phase distributor 62 divides the input clock into four 16 MHz clocks having different phases.

Hereinafter, the phase distributor 62 will be described in greater detail with reference to FIG. 8. FIG. 8 illustrates a structure of a phase distributor (shown in FIG. 6) for frequency division.

As shown in FIG. 8, when 64 MHz is input to a first flip-flop 81, a half-reduced frequency is output. Also, from the first flip-flop 81, two kinds of phases are output: the same phase (A) as an input phase; and an inverted phase (B), and then the phases are input to second and third flip-flops 82, respectively. Herein, 0° phase and 180° phase at 32 MHz are input to a second flip-flop #2 and a third flip-flop #3, respectively, to generate half-reduced frequencies, thereby resulting in generation of clocks having four phases at 16 MHz.

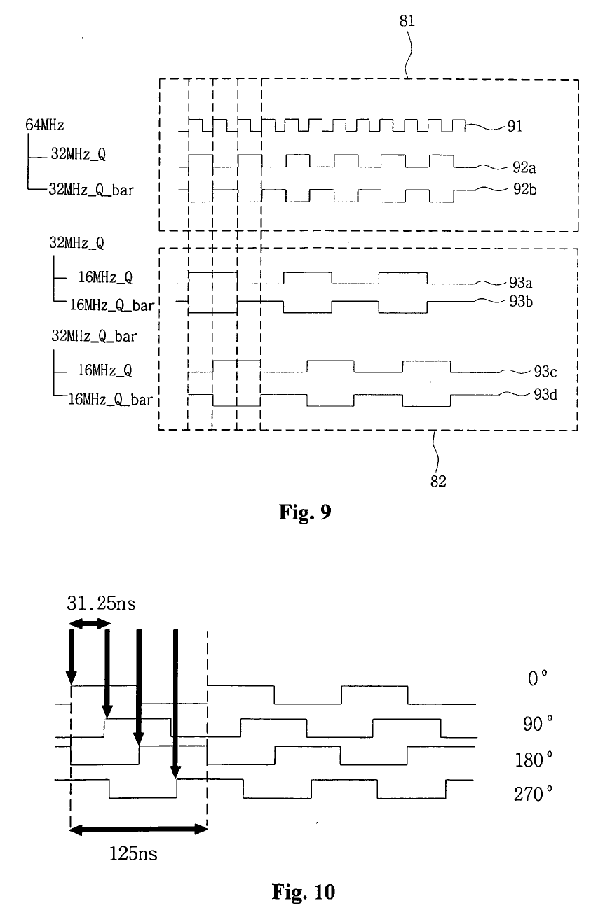

FIG. 9 illustrates a process of generating a clock. Referring to FIG. 9, the first flip-flop 81 outputs 32 MHz signals 92a and 92b from a 64 MHz signal 91, and the signals are input to an input unit of the second and third flip-flops 82, respectively, thereby generating four half-reduced frequency (16 MHz) signals: 0° 93a, 90° 93c, 180° 93b, and 270° 93d. The divided phases are used as clock sources for respective RF receiving modules of the multiple as RF receiving unit 64.

Accordingly, precise digital clocks, instead of analogue clocks, may be used as clock sources, so as to minimize a decoding jitter caused by a clock cycle as shown in FIG. 5.

FIG. 10 illustrates, in order, phase shifts resulting from the process of FIG. 9. Referring to FIG. 10, when the multiple RF receiving unit 64 receives messages at once from clocks whose phases are regularly shifted, a certain RF receiving module having a rising edge at a reception point of a radio frequency signal firstly performs time measurement.

Especially, in the present invention, in order to obtain a radio frequency signal (that is, a RF signal), the multiple RF receiving unit 64 reduces uncertainty of a radio signal by using a common antenna. In other words, although the multiple RF receiving unit 64 uses multiple RF receiving modules, the RF receiving modules are connected to one common antenna, instead of separate antennas.

The time measuring unit 65 measures SFD (Start of Frame Delimiter) signals transmitted from respective RF receiving modules of the multiple RF receiving unit 64, and utilizes the first one of the SFD signals as data required for location measurement. Also, when a message is obtained by using four phases, a chip rate four times greater than a conventional single RF transceiver 42, may be obtained. When a chip rate of the multiple RF receiving unit 64 is 8 MHz, a clock cycle is 125 nanoseconds (ns), whereas when N RF receiving modules are used, a chip rate is N times greater than that (8 MHz) of the multiple RF receiving unit 64.

Meanwhile, in order to exactly measure a location of a transmitter, receivers are required to be precisely time-synchronized down to a nanosecond. As described above, a time synchronization error of 1 nanosecond causes a location error of 30 centimeters. In time-synchronization between receivers of an RTLS, an infrastructure, such as internet, is used. However, infrastructure equipment for a wired environment causes difficulty in extension and an increase in cost. Therefore, in order to secure extension of an RTLS and to reduce cost, time-synchronization between RTLS receivers is achieved by using a wireless network requiring no infrastructure.

A system for time-synchronization basically includes a master receiver for providing a reference time and a slave receiver for synchronizing its time by receiving the reference time from the master receiver. The time-synchronization between the receivers is carried out through a message exchange.

For the time-synchronization between the master receiver and the slave receiver, the master receiver periodically transmits a time synchronization message including time information. This may be preferably defined by a time-related equation (Equation 1).

Reception time−send time=transmission time+measurement error [Equation 1]

In Equation 1, the reception time represents a time when a slave receiver received a time synchronization message, and the send time represents a time when a master receiver transmitted the time synchronization message. The transmission time represents a constant calculated through a distance from the master receiver to the slave receiver by using a radio frequency. A transmission speed of a radio signal corresponds to the speed of light (3×108).

Since light reaches by 30 centimeters per 1 nanosecond, the transmission time may be calculated by the distance from the master receiver to the slave receiver. In other words, the transmission time may be calculated by the transmission speed of a radio signal, provided that the distance from the master receiver to the slave receiver is known.

Meanwhile, the above mentioned three values can be measured or calculated, while it is impossible to know the measurement error. Such a measurement error may occur during a process of converting a radio frequency to digital data.

As described above, FIG. 5 illustrates an example of a jitter that may occur in the RF transceiver 42. Such an error is a jitter which may vary according to radio frequency signal measurement. However, through the multiple RF receiver 60 according to an embodiment of the present invention (see FIG. 6), it is possible to minimize a measurement error occurring during time-synchronization between receivers, and to achieve time-synchronization down to a nanosecond.

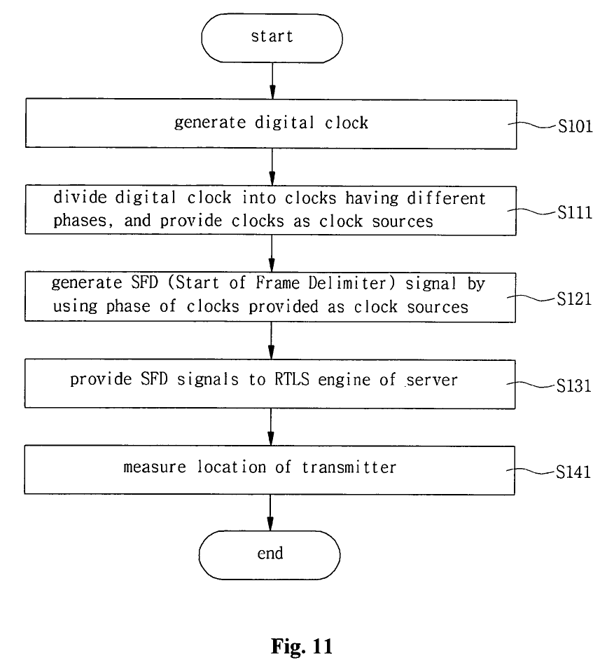

FIG. 11 is a flow chart showing a locating method using the multiple RF receiver according to an embodiment of the present invention.

As described above, since a jitter is minimized through the multiple RF receiver 60, it is possible to more precisely measure the location of the RTLS transmitter by removing an error in location measurement.

First, the clock generator 61 generates a digital clock by amplifying a frequency according to the number of multiple RF receiving modules included in the multiple RF receiving unit 64 in step S101 (refer to FIG. 7 for more detailed description).

Next, the phase distributor 62 divides the digital clock into clocks having different phases so as to provide the clocks to the multiple RF receiving unit 64 as clock sources in step S111. Herein, the phase distributor 62 may use a flip-flop so as to shift a phase of a digital clock (refer to FIG. 8 for more detailed description).

Then, in step S121, the multiple RF receiving unit 64 generates SFD (Start of Frame Delimiter) signals by using the phases of the clocks provided as clock sources. Herein, the multiple RF receiving unit 64 may receive a radio frequency (clock) by using one common antenna.

In step S131, the time measuring unit 65 measures the SFD signals and provides the result to an RTLS engine (server). Herein, the time measuring unit 65 may use the first one of the measured SFD signals as data required for location measurement.

Next, the RTLS engine measures a location of a transmitter by using received information in step S141.

As described above, through the multiple RF receiver according to the present invention and a locating method using the same, it is possible to minimize a jitter occurring in a receiver, the jitter having the strongest effect on location measurement, thereby making it possible to precisely measure a signal. In addition, through improvement in a chip rate in radio communication, the device according to the present invention may be utilized for various applications, such as precise time-synchronization, or the like. Also, in the time-synchronization, the device according to the present invention is based on a wireless network requiring no infrastructure, such as internet. Also, there is an advantage in that receivers locally time-synchronize with each other without an external time server. Also, in the present invention, uncertainty occurring during time-synchronization using a wireless network is removed, thereby making it possible to perform time-synchronization down to a nanosecond.

Meanwhile, respective components as shown in FIG. 6 may be included as modules. The ‘modules’ indicate hardware components, such as software, field programmable gate array (FPGA), or application specific integrated circuit (ASIC), and perform certain functions. However, such modules are not limited to software or hardware. The modules may be included in an addressing storage medium, or may be configured to perform one or more processors. The components and modules may include sub-components/modules or may further include additional components/modules.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A multiple RF receiver comprising:
a clock generator for generating a clock;
a phase distributor for dividing the generated clock into clocks having different phases according to multiple RF receiving modules included in a multiple RF receiving unit, and providing the divided clocks to the multiple RF receiving unit as clock sources;
said multiple RF receiving unit comprising the multiple RF receiving modules which generate SFD(Start of Frame Delimiter) signals, respectively, by using the phases of the clocks provided as the clock sources; and
a time measuring unit for measuring the SFD signals for use as data for location measurement.

2. The multiple RF receiver as claimed in claim 1, wherein the multiple RF receiving unit uses one common antenna to receive radio frequencies.

3. The multiple RF receiver as claimed in claim 1, wherein the time measuring unit uses a first signal of the measured SFD signals as the data for the location measurement.

4. The multiple RF receiver as claimed in claim 1, wherein the phase distributor changes a phase of the generated clock by using a flip-flop.

5. The multiple RF receiver as claimed in claim 1, wherein the time measuring unit sets end of each of the SFD signals as a time stamp.

6. The multiple RF receiver as claimed in claim 1, which comprises one master receiver for periodically transmitting a time synchronization message comprising time information, and a slave receiver for synchronizing its time by receiving a reference time from the master receiver based on the SFD signals generated by the multiple RF receiving unit.

7. A multiple RF receiver comprising:
a multiple RF receiving unit comprising multiple RF receiving modules which generate SFD signals, respectively, by using clocks provided as clock sources;
a phase distributor for dividing a clock input from a clock generator into the clocks having different phases according to the multiple RF receiving modules, and providing the divided clocks to the multiple RF receiving unit as the clock sources; and
a time measuring unit for measuring the SFD signals for use as data for location measurement.

8. The multiple RF receiver as claimed in claim 7, wherein the multiple RF receiving unit uses one common antenna to receive radio frequencies.

9. The multiple RF receiver as claimed in claim 7, wherein the phase distributor changes a phase of the clock by using a flip-flop.

10. The multiple RF receiver as claimed in claim 7, which comprises: one master receiver for periodically transmitting a time synchronization message comprising time information to other receivers; and a slave receiver for synchronizing its time by receiving the time synchronization message transmitted from the master receiver, based on the SFD signals generated by the multiple RF receiving unit.

11. A method of measuring a location of a transmitter by using a time difference of arrival (TDOA) of radio frequencies in a locating system comprising multiple receivers, one transmitter, and an RTLS engine, the method comprising steps of:
(a) generating a clock by a clock generator;
(b) dividing, by a phase distributor, the generated clock into clocks having different phases according to multiple RF receiving modules included in a multiple RF receiving unit, and providing the divided clocks to the multiple RF receiving unit as clock sources;
(c) generating, by the multiple RF receiving unit, SFD signals through the RF receiving modules by using the phases of the clocks provided as the clock sources; and
(d) measuring, by a time measuring unit, the SFD signals to be provided to the RTLS engine, thereby allowing the RTLS engine to measure the location of the transmitter by using the SFD signals.

12. The method as claimed in claim 11, wherein in step (b), a flip-flop is used to change a phase of the generated clock.

13. The method as claimed in claim 11, further comprising, before step (a), the steps of: transmitting periodically, by one master receiver of the multiple receivers, a time synchronization message comprising time information to other receivers; and receiving, by the other receivers of the multiple receivers, except the master receiver, the time synchronization message transmitted from the master receiver, and synchronizing their times based on the SFD signals generated by the multiple RF receiving unit.

14. The method as claimed in claim 13, wherein the phase distributor time-synchronizes the clocks to be provided to the multiple RF receiving unit as the clock sources, according to a clock received from the master receiver.

15. The method as claimed in claim 11, wherein in step (c), one common antenna is used for receiving the clocks.

16. A method of measuring a location of a transmitter by using a time difference of arrival (TDOA) of radio frequencies in a locating system comprising multiple receivers, one transmitter, and an RTLS engine, the method comprising steps of:
(A) dividing, by a phase distributor, a clock generated by a clock generator into clocks having different phases according to multiple RF receiving modules included in a multiple RF receiving unit, and providing the divided clocks to the multiple RF receiving unit as clock sources;
(B) generating, by the multiple RF receiving unit, SFD signals through the RF receiving modules by using the phases of the clocks provided as the clock sources; and
(C) measuring, by a time measuring unit, the SFD signals to be provided to the RTLS engine, thereby allowing the RTLS engine to measure the location of the transmitter by using the SFD signals.

17. The method as claimed in claim 16, further comprising, before step (A), the steps of: transmitting periodically, by one master receiver of the multiple receivers, a time synchronization message comprising time information to other receivers; and receiving, by the other receivers of the multiple receivers, except the master receiver, the time synchronization message transmitted from the master receiver, and synchronizing their times based on the SFD signals generated by the multiple RF receiving unit.

18. The method as claimed in claim 17, wherein the phase distributor time-synchronizes the clocks to be provided to the multiple RF receiving unit as the clock sources, according to a clock received from the master receiver.

19. The method as claimed in claim 16, wherein in step (B), one common antenna is used for receiving the clocks.
